(19) United States
(12) Patent Application Publication
(10) Pub. No.: US 2008/0297759 A1
(43) Pub. Date: Dec. 4, 2008

(54) Device for Optical Distance Measurement

(76) Inventors: Uwe Skultety-Betz, Leinfelden-Echterdingen (DE); Peter Wolf, Leinfelden-Echterdingen (DE)

Correspondence Address: Striker Striker & Stenby, 103 East Neck Road, Huntington, NJ, 11743, US

(21) Appl. No.: 10/582,901

(22) PCT Filed: Mar. 31, 2005
(86) PCT No.: PCT/EP2005/051454

§ 371 Date: Jun. 13, 2006

(30) Foreign Application Priority Data
May 14, 2004 (DE) 102004023998.3

(51) Int. Cl. G01C 3/00

(52) U.S. Cl. 356/3

(57) ABSTRACT

The invention relates to a device for optical distance measurement, in particular a handheld device, having an emission branch (14) which defines a emission channel and has at least one emission unit (22, 24) for emitting modulated optical radiation (36) in the direction of a target object (20), having a reception branch (18) which defines a reception channel (44) and has at least one receiver (54), and having a reference branch (15) which defines a reference path (40), and having switch means (38) for deflecting the measurement signal (36) between the emission branch (14) and the reference branch (15).

According to the invention, it is proposed that the switch means (38) are mechanically driven.

### PRIOR ART

The present invention is based on a device for optical distance measurement, in particular a handheld device for optical distance measurement, as generically defined by the preamble to claim 1.

### PRIOR ART

Distance measuring devices and in particular optoelectronic distance measuring devices per se have been known for a relatively long time and by now are also commercially available. These devices emit a modulated measuring beam, for instance a beam of light in the form of a laser beam, which is aimed at a desired target object whose distance from the device is to be ascertained. The returning measurement signal, reflected or scattered by the target object aimed at, is at least partly detected again by a sensor of the device and used for finding the distance sought.

In the known devices in the prior art, a distinction is made between so-called phase measuring methods and purely transit time measuring methods for determining the distance sought to the target object. In the transit time measuring methods, a light pulse of as short a pulse duration as possible is emitted by the measuring device, and then its transit time to the target object and back again into the measuring device is ascertained. With the known value for the speed of light, the distance of the measuring device from the target object can be calculated from the transit time of the light.

In the phase measuring methods, the change in phase of the modulated measurement signal as a function of the distance traveled is used to determine the distance between the measuring device and the desired target object. From the magnitude of the phase displacement impressed on the returning measurement signal, compared to the phase of the emitted measurement signal, the distance traveled by the measurement signal and thus the distance from the measuring device to the target object can be determined.

The range of application of such distance measuring devices generally include distances ranging from a centimeters to several hundred meters. Such measuring devices are by now commercially sold in compact versions and make simple operation, for instance even handheld operation, possible for the commercial or the private user.

To attain high measurement accuracy with such a device, the device typically has an internal reference path of a known length, over which the measurement signal can be conducted directly to a receiver of the measuring device. This internal reference path serves to calibrate the measuring device and in particular to take short-term drifting in the components of the device for optical distance measurement into account.

From European Patent Disclosure EP 0 738 899 A1, a device for optical distance measurement of this generic type is known in which the pulse-modulated measurement radiation can be conducted, by means of a switchable beam deflector, to an internal reference path between the semiconductor laser serving as a light source and a receiver of the device. In the device for optical distance measurement of EP 0 738 899 A1, a switchable beam deflector is located immediately upstream of an optical exit slit of the measurement radiation from the measuring device, and the deflector can be pivoted by motor about an axis. The surface of the beam deflector that is acted upon by the focused measurement beam scatters light, creating a divergent scattered cone. If the beam deflector is switched into the emission branch of the device, then the measurement signal is deflected directly onto an optical waveguide inlet face. The optical waveguide, on its end diametrically opposite the optical waveguide inlet face, has an optoelectric converter, which converts the optical measurement signals into electrical measurement signals and delivers them to further evaluation.

From German Patent Disclosure DE 196 43 287 A1, a method and a device for calibrating distance measuring devices are known, in which some of the emitter radiation of the distance measuring device is always out-coupled as reference radiation and carried over a calibration path to a reference receiver. In this way, the phase displacements generated by temperature drift of the emitter, for instance, which impress themselves on both the reference signal and the received signal, can compensate for one another.

The object of the invention is to implement an internal reference path in the device in a simple, reliable, and economical way.

The object of the invention is attained with a device for optical distance measurement as defined by the characteristics of claim 1.

### ADVANTAGES OF THE INVENTION

The device of the invention for optical distance measurement as defined in claim 1 has an emission branch, with at least one emission unit, for emitting modulating, optical measurement radiation in the direction of a target object. The device of the invention for optical distance measurement furthermore has a reception branch with at least one receiver as well as a reference branch that defines a reference path. The modulated, optical measurement radiation can be switched over between the emission branch and the reference branch by switch means, in order to perform a distance measurement or calibration measurement selectively. Advantageously, the switch means for deflecting the measurement radiation between the reception branch and the reference branch is operated purely mechanically. In this way, a simple, reliable, and above all electrically economical way of generating an internal reference path can be achieved.

Devices for optical distance measurement and in particular handheld devices of this kind are usually operated independently of the power grid by means of nonrechargeable or rechargeable batteries. Purely mechanical switch means do not represent additional consumers for the energy that is only limitedly stored in the measuring device, so that because the switch means of the reference path are embodied according to the invention, the service life of the measuring device, per set of nonrechargeable or rechargeable batteries, is increased markedly.

By the provisions recited in the dependent claims, advantageous refinements of the device defined by the independent claim are possible.

Advantageously, the switch means for switching over the measurement signal from the reception branch to the reference branch or vice versa is activated by the work which a user, on actuating a user control element of the device of the invention, is supposed to perform. Optoelectronic distance meters as a rule have a plurality of user control elements, whose actuation requires the performance of a certain quantity of mechanical work. This mechanical work to be exerted by the device user can advantageously be utilized for actuating the switch means of the internal reference path of the device.

In an especially advantageous embodiment of the device according to the invention for optical distance measurement, the switch means of the reference path are embodied such that the measurement signal traverses the reference path, as long as no distance measurement is being performed. In this way, it is possible for the switch means for deflection to be implemented by the particular user control element of the device that actively starts a measuring operation. Thus the switch means are operated by the measurement button for initiating a measurement operation, or by the work done by the user at this measurement button.

In an advantageous embodiment of the device of the invention for optical distance measurement, the switch means are meant to be actuated counter to the force of a spring-elastic element or of a lever element. In this way, the switch means can be embodied such that they simultaneously serve as a closure element for the emission branch of the device of the invention. The work expended by the user is utilized in order to switch the switch means in such a way that the emission branch is opened and the modulated measurement signal can leave the measuring device in the direction of a target object. When the measurement button is released, the switch means are returned to their original position, because of the spring or lever action coupled to them. The measurement signal can then no longer leave the measuring device. It is deflected by the switch means, for instance so that within a predetermined measuring device interval it serves to make a reference measurement. This means that not until measurement button is pressed is the switch device actuated and the optical measurement signal made visible to the user. The target object can then be aimed at, and for instance by releasing the measurement button, an updated measured value for the distance from the target object being aimed at the moment is stored in memory.

Further advantages of the device of the invention will become apparent from the drawings and the associated description.

### DRAWINGS

In the drawings, one exemplary embodiment of a device according to the invention for optical distance measurement is shown, which will be described in further detail in the ensuing description. The drawing figures, their description, and the claims directed to the invention include numerous characteristics in combination. One skilled in the art will consider these characteristics and the claims directed to them individually as well and put them together to make further useful combinations and claims, which are thus here likewise to be considered as having been disclosed.

Shown are:

FIG. 1, a device for optical distance measurement, in a simplified, schematic total overview;

FIG. 2, a perspective view of a device for optical distance measurement of the invention, seen obliquely from above;

FIG. 3, a detail of a switch means of the reference path of the device of the invention in the non-activated state;

FIG. 4, the detail of the reference path of FIG. 3 in the activated state.

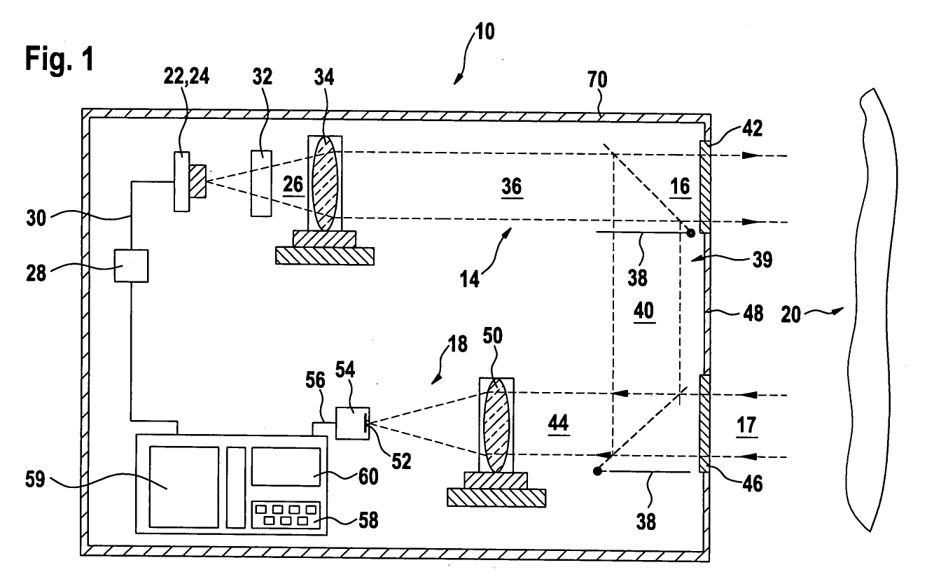

In FIG. 1, a device for optical distance measurement 10 is shown schematically with the most important of its components, for the sake of describing its basic construction. The device 10 for optical distance measurement has a housing 70, in which both an emission branch 14 for generating an optical measurement signal 36 and a reception branch 18 for detecting the measurement signal 17 returning from a target object 20 are embodied.

The emission branch 14, along with a series of components not further shown, in particular has a light source 22, which in the exemplary embodiment of FIG. 1 is embodied as a semiconductor laser diode 24. The use of other light sources in the emission branch 14 of the device of the invention is equally possible, however. The laser diode 24 in the exemplary embodiment of FIG. 1 emits a laser beam in the form of a beam of light 26 that is visible to the human eye. To that end, the laser diode 24 is driven via a control unit 28, which by means of suitable electronics generates a modulation of the electrical input signal 30 to the diode 24. The control unit 28 in turn receives the necessary frequency signals of the laser diode from a control and evaluation unit 58 of the measuring device of the invention. In other exemplary embodiments, the control unit 28 may also be a direct integral component of the control and evaluation unit 58.

The control and evaluation unit 58 includes a circuit arrangement 59, which among other elements has a quartz oscillator for furnishing the required frequency signals. With these signals, a plurality of which at different frequencies are typically used during the distance measurement, the optical measurement signal is modulated in a known manner. The basic construction of such a device and the corresponding method for generating different measurement frequencies can be learned for instance from German Patent DE 198 11 550 C2, so that at this point this reference is merely referred to, and the contents of the reference cited are meant to be the contents of this application as well. Within the context of the description to be made here, the details of the frequency generation and of the measuring method will therefore not be addressed in further detail.

The intensity-modulated beam of light 26 emerging from the semiconductor diode 24 passes through a first optical element 32, which leads to an improvement in the beam profile of the measuring beam. By now, an optical element of this kind is typically an integral component of a laser diode. The measuring beam 26 then passes through a collimation lens 34, which generates a virtually parallel focused light beam 36.

In the emission branch 14 of the device of the invention as shown in FIG. 1, there is also a device 39 with switch means 38 for generating an internal reference path 40 of the device, with which an internal calibration of the measuring device can be performed. If the switch means 38, which are shown only symbolically in FIG. 1, are adjusted in such a way that the measuring beam 36 is coupled into the reference path 40, then the measurement radiation is directed directly at the receiver 54 of the reception branch 18 of the device of the invention. Because the optical length of the reference path 40 is known very precisely, a reference signal obtained in this way can used for calibrating the device of the invention and in particular for evaluating the phase displacement to be ascertained.

However, if as shown in FIG. 1 the switch means 38 are actuated, then the measurement signal 36 is out-coupled from the housing 70 of the device 10, through an optical slit 42. This can for instance be done, as will be described hereinafter, by actuation of a user control element, not further shown in FIG. 1, of the keypad of the device of the invention. The measuring beam 36 then exits from the measuring device 10 in the form of a modulating measurement signal 16 and strikes the desired target object 20, whose distance from the measuring device 10 is to be ascertained. The signal 17, reflected or even scattered by the desired target object 20, reaches the housing 70 of the device 10 of the invention again a certain proportion through an inlet slit 46. The measurement radiation arriving through the inlet slit 46 in the face end 48 of the device 10 forms a returning measurement beam 44, which is directed to a receiving lens 50. The receiving lens 50 focuses the returning measurement beam 44 at the active face of a receiver 54.

The receiver 54 of the device of the invention has a photodiode 52, which in a known way converts the arriving light signal 17 into an electrical signal, which is then carried onward via suitable electrical connecting means 56 to a control and evaluation unit 58 of the device 10. From the returning optical signal 17, and in particular from the phase displacement impressed on a returning signal in comparison with the phase of the originally emitted signal 16, the control and evaluation unit 58 ascertains the distance sought between the device 10 and the target object 20. The distance thus ascertained can be imparted to the user of the device, for instance in an optical display device 60.

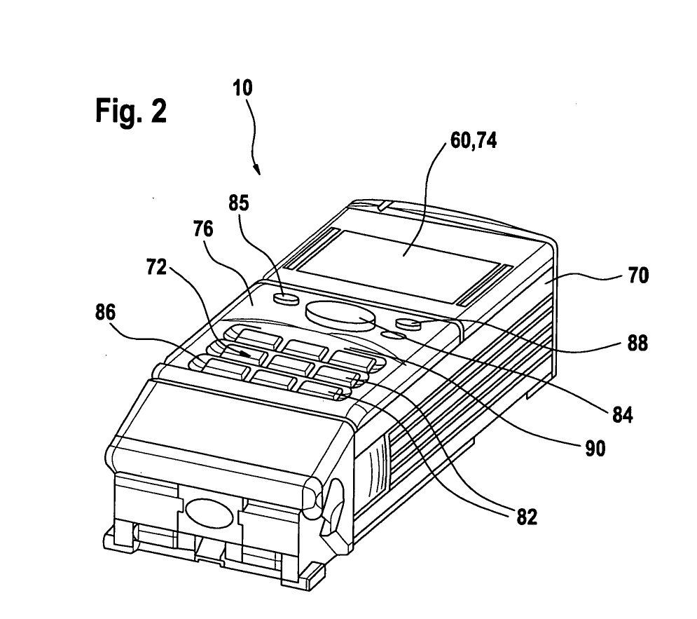

FIG. 2 shows a handheld laser distance measuring device as one exemplary embodiment of the device 10 of the invention for optical distance measurement. The laser distance measuring device of FIG. 2 has a housing 70, in which a first user control unit 72, an output unit 74 in the form of a graphical display 60, and a second user control unit 76 are integrated. The first user control unit 72 includes an input unit with user control keys 82 for selecting a measurement mode, such as length, area, or volume measurement. The user control keys 82 of the first user control unit 72 are recessed in indentations 86 of the housing 70.

The second user control unit 76 includes a button 85 for switching the device on and off, a button 88 for lighting up the display 60, and a measurement button 84 for performing a distance measurement.

The measurement button 84 and the second user control unit 76 located in the immediate vicinity of the measurement button 84 are separated from the control keys 82 of the first user control unit 72 by a riblike raised area 90.

If the measurement button 84 is actuated, the switch means 38 are actuated simultaneously, and they open the emission branch 14 of the device of the invention for the measurement signal.

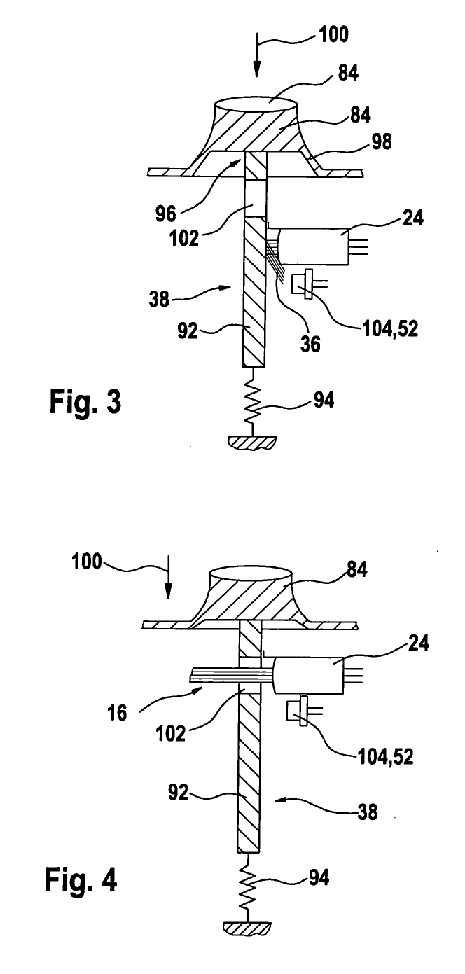

In FIGS. 3 and 4, the relationship between the actuation of the measurement button 84 and the actuation of the switch means for the reference path of the device of the invention are shown in a schematic detail view. FIG. 3 shows the embodiment of switch means 38 for deflecting the measurement signal onto a reference path 40 or onto the measurement path, in terms of a schematic illustration of a detail.

The switch means 38 have a two-dimensionally embodied slide element 92, which is shown in section in FIG. 3. The slide element 92 is prestressed on one, lower end in terms of FIG. 3 with the aid of a spring element 94. By means of the spring element 94, the slide element 92 is pressed with its end 96 remote from the spring element against the inner region of the measurement button 84. The measurement button 84 is embodied as a reciprocating button, which is prestressed by an elastic ring element 98. For actuation of the measurement button 84, or in other words for initiating a distance measurement, the user of the device of the invention must actuate the measurement button 84 in the direction of the arrow 100, counter to the prestressing of the elastic ring element 98.

The switch means 38, in its slide element 92, has a through opening 102, through which, given a suitably positioned switch element 38, the measurement radiation can pass. When the measurement button 84 is not activated, the switch element 38 is located in such a way that the measurement radiation 36 exiting the laser diode 24 is reflected by the slide element 92 and carried to a receiving diode 104. The receiving diode 104 can be a separate, additional further diode, or it can also be the photodiode 52 of the receiver 54 of FIG. 1. The distance between the laser diode 24 and the receiving diode 104 or 52, which is shown only schematically in FIG. 3, is used as an internal reference path 40 for calibration of the distance meter of the invention. The measuring beam, deflected by the slide element 92 and striking the receiving unit can thus be called up at a predetermined time interval by the internal control and evaluation unit of the device and utilized for calibrating the measuring device.

If, as indicated in FIG. 4, the measurement button 84 is actuated in the direction of the arrow 100, then by means of the mechanical work done at the measurement button 84, the slide element 92 is displaced counter to the tension of the elastic ring element 98 and of the spring element 94, so that the through opening 102 is brought to the level of the laser diode 24. In this way, the emission branch 14 is opened for the modulated measurement radiation, so that the measurement signal 16 can exit from the device of the invention and be emitted in the direction of a target object. In this arrangement, the distance can for instance be measured continuously. If the measurement button 84 is let go again, then on the one hand the most recent measured value of the distance measurement can be stored in a memory element of the control and evaluation unit of the device of the invention. On the other, the slide element 92 is displaced back to its outset position, counter to the direction of the arrow 100, by the spring force of the spring element 94 once the measurement button 84 is no longer active. The emission branch 14 is thus closed again, and hence no emitted signal can exit from the measuring device of the invention. By reflection from the slide element 92, the measurement radiation 36 of the laser diode 24 is now deflected back toward the receiving diode 52 or 104, so that if that should be necessary and/or intended, the measurement radiation is available for a further reference measurement.

Advantageously, the switch element for switching over the measurement signal between the emission branch and the reference branch thus simultaneously forms a closure means for the exit opening from the device of the invention for optical distance measurement. By utilizing the actuation force for the measurement button, it is possible in a simple and reliable way for the switch element to be actuated for deflecting the optical radiation between the reference path and the measurement path. The expenditure of force by the user is then utilized solely to open the measurement path, if necessary.

The device of the invention is not limited to the embodiments shown in the exemplary embodiments.

For instance, instead of the spring element 94 for prestressing the switch means, a lever construction or other mechanical adjusting moments can also be used.

The switching function of the measurement button 84 can be embodied as a double-stroke button, for instance, whose first stroke leads to enabling the measurement signal into the emission branch, and whose second stroke can then serve to pick up a measurement finding.

The device of the invention makes a simple, reliable and economical embodiment possible for implementing a reference path for a device for optical distance measurement. Advantageously, a switch function that is necessary anyway is utilized for switching the switchover for the reference path as well.

1. A device for optical distance measurement, in particular a handheld device, having an emission branch (14) which defines an emission channel and has at least one emission unit (22, 24) for emitting modulated optical radiation (36) in the direction of a target object (20), having a reception branch (18) which defines a reception channel (44) and has at least one receiver (54), and having a reference branch (15) which defines a reference path (40), and having switch means (38) for deflecting the measurement signal (36) between the emission branch (14) and the reference branch (15), characterized in that the switch means (38) are mechanically driven.

2. The device as defined by claim 1, characterized in that the switch means (38) are driven by mechanical work that is to be performed by a user at a user control element (84) of the device.

3. The device as defined by claim 2, characterized in that the switch means (38) are operated by the measurement button (84) for performing a distance measurement.

4. The device as defined by claim 1, characterized in that the switch means (38) are to be actuated counter to the restoring force of an adjusting moment.

5. The device as defined by claim 4, characterized in that the switch means (38) are to be actuated counter to the force of at least one spring-elastic element (94, 98).

6. The device as defined by claim 1, characterized in that the switch means (38) are embodied such that the measurement radiation (36) traverses the reference path (40), if the switch means (38) are not activated.

7. The device as defined by claim 1, characterized in that the switch means (38) close the emission branch (14) in the event that the measurement button (84) for activating a distance measurement is not activated.
